(19) United States
(12) Patent Application Publication
(10) Pub. No.: US 2012/0141045 A1
(43) Pub. Date: Jun. 7, 2012

(54) METHOD AND APPARATUS FOR REDUCING BLOCK ARTIFACTS DURING IMAGE PROCESSING

(75) Inventors: Soo Hyun BAE, San Jose, CA (US); Wenhui XU, Pooler, GA (US)

(73) Assignee: SONY CORPORATION, Tokyo (JP)

(21) Appl. No.: 12/957,988

(22) Filed: Dec. 1, 2010

(51) Int. Cl. G06K 9/40

(52) U.S. Cl. 382/275

(57) ABSTRACT

A method and apparatus for reducing artifacts during image processing is described. In some embodiments, the method includes examining an input image comprising at least one source region, for each target region in an output image, identifying a portion of the at least one source region based on similarity data, defining an omnidirectional cut boundary and determining intensity values for the each target region and at least one pixel between the each target region and the omnidirectional cut boundary.

### BACKGROUND

1. Technical Field

Embodiments of the present disclosure generally relate to image processing systems and, more particularly, to a method and apparatus for reducing block artifacts during image processing.

2. Description of the Related Art

Image capturing and/or video recording devices constitute a significant portion of the current global consumer electronics market. The widespread usage of such image processing devices brings to light various defects. For example, these devices store images and/or video frames form target regions or unknown groups of pixels. These target regions can be unwanted or missing pixel regions for image processing. There may be a pet captured wandering in a background of a family portrait of which the user desires removal of that pet from any digital copies. As another example, several portions of an input image may be blended or combined into a graphical mesh in which instance the target regions include the resulting image.

Current image processing devices use arbitrary candidate patch sizes and shapes for determining intensity values for missing or unknown pixels of a target region. The candidate patches are arbitrary because these devices cannot identify which source region pixels are needed to correctly inpaint the target region. The current devices define the candidate patch size and shape based on the target region size and shape. Since these devices employ a fixed or limited number of target regions, these devices are unable to define a flexible size and shape of the target region of each portion of an image to be inpainted.

Furthermore, processing and storing the images causes artifacts. Artifacts, generally, include noticeable distortions of media (e.g., an image, audio and/or video) due to the application of an overly aggressive or inappropriate lossy data compression algorithm. For example, certain block-based inpainting techniques cause these noticeable distortions. When such an image is received, a block-by-block decoding of the image is performed to reconstruct the transferred image. The quantization of the individual image blocks is necessarily associated with a loss of information that can result in visible edges at the block boundaries during the reconstruction. These artifacts can be especially prominent when a very rough quantization is provided corresponding to large quantization parameters.

Therefore, there is a need in the art for an improved method and apparatus for reducing artifacts during image processing by using a more accurate target region.

### SUMMARY

Various embodiments of the present disclosure generally comprise a method and apparatus for reducing artifacts during image processing. In some embodiments, the method includes examining an input image comprising at least one source region, for each target region in an output image, identifying a portion of the at least one source region based on similarity data, defining an omnidirectional cut boundary and determining intensity values for the each target region and at least one pixel between the each target region and the omnidirectional cut boundary.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a device for reducing artifacts during image processing in accordance with at least one embodiment;

FIG. 2 is a functional block diagram illustrating a camera that reduces artifacts during image processing in accordance with at least one embodiment;

FIG. 3 is a functional block diagram illustrating a process for reducing artifacts while converting an input image into an output image in accordance with at least one embodiment;

FIG. 4 is a flow diagram of a method for reducing artifacts during image processing in accordance with at least one embodiment;

FIG. 5 is a flow diagram of a method for defining an omnidirectional cut boundary for a target region within a block of pixels in accordance with at least one embodiment;

FIG. 6 is a flow diagram of a method for determining a omnidirectional cut boundary that defines an accurate target region in accordance with at least one embodiment;

FIG. 7 is a schematic of an image to be processed in accordance with at least one embodiment;

FIG. 8 illustrates a minimum cut process for reducing artifacts during image processing in accordance with at least one embodiment; and

FIG. 9 illustrates block-based image processing that reduces artifacts using an accurate target region in accordance with at least one embodiment.

### DETAILED DESCRIPTION

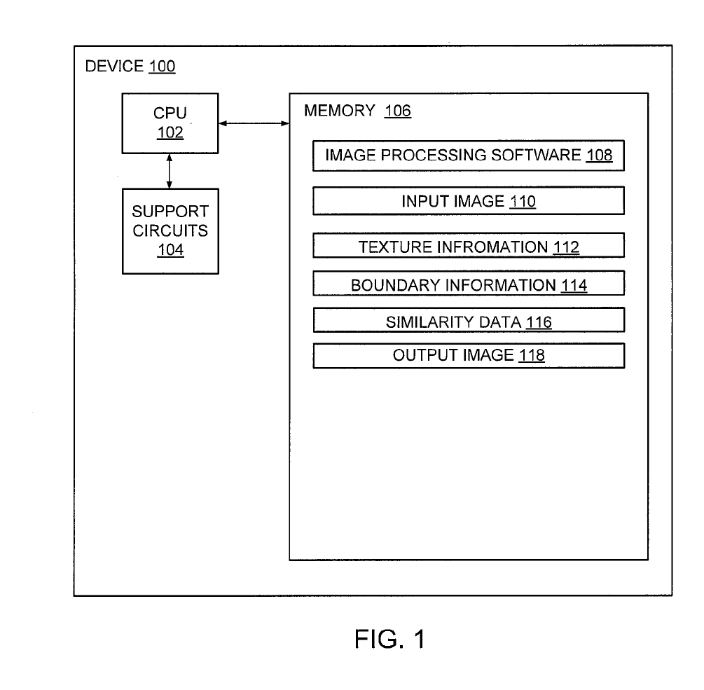

FIG. 1 illustrates a block diagram of a device 100 for reducing artifacts during image processing in accordance with at least one embodiment. Such a target region may be used for any image processing technique, such as 3-D scene generation 2D/3D image magnification, image editing, compression, synthesis, object removal, 2D to 3D conversion and/or the like. The device 100 is a type of computing device (e.g., a laptop, a camera, a desktop, a server, a mobile device, a multimedia recording device and/or the like) that comprises a Central Processing Unit (CPU) 102, support circuits 104 and a memory 106. The CPU 102 comprises one or more commercially available microprocessors or microcontrollers that facilitate data processing and storage. The support circuits 104 facilitate operation of the CPU 102 and include clock circuits, buses, power supplies, input/output circuits and/or the like. The memory 106 includes a read only memory, random access memory, disk drive storage, optical storage, removable storage, and the like.

The memory 106 further includes various software packages, such as the image processing software 108. The memory 106 further stores various data, such as an input image 110, texture information 112, boundary information 114, similarity data 116 and an output image 118. The similarity data 116 includes various information indicating degrees of similarity between pixels or groups of pixels. In some embodiments, the similarity data 116 includes cut energies for each pixel including start pixels and finish pixels. In other embodiments, the similarity data 116 includes distortion values between a pixel in the target region and a pixel in the source region.

The image processing software 108 includes software code (processor executable instructions) for determining a cut boundary that defines an accurate target region of the input image 110. The image processing software 108 stores pixel locations that form the cut boundary in the boundary information 114. The image processing software 108 searches the input image 110 and identifies a source region that best matches (i.e., most similar) to known pixels that surround the target region. The image processing software 108 proceeds to identify a portion of the source region that is equal in area or larger than the target region. That portion of the source region is expanded to include the surrounding pixels within the cut boundary. The image processing software 108 inpaints the expanded target region by copying Intensity from the portion of the source region according to some embodiments.

In some embodiments, the each pixel includes a five-component representation that can be expressed as an image processing tensor that includes at least a single dimensional image processing matrix (i.e., vector) for at least a two-dimensional image. An exemplary embodiment of such a matrix is as follows:

$$[ \begin{matrix}{x}_{1} \\ {x}_{2} \\ {x}_{3} \\ {\partial }_{h} x \\ {\partial }_{v} x\end{matrix} ]$$

This image processing matrix includes primary color components [x₁, x₂, x₃] for the input image 110, ∂ₕx (i.e., the product of partial derivative along a horizontal direction and a normalization of the primary color components) and ∂ᵥx (i.e., the product of partial derivative along a vertical direction and a normalization factor of the primary color components). x₁, x₂ and x₃ are intensity values for the primary color components (e.g., red, green, blue (RGB) components), where each intensity value represents an amount or saturation of a particular color in the pixel. For example, if the pixels include a full or strong intensity for each primary color component, the input image 110 appears completely white. In addition, an intensity value for a block of pixels may be approximated or computed without examining the intensity values for each pixel.

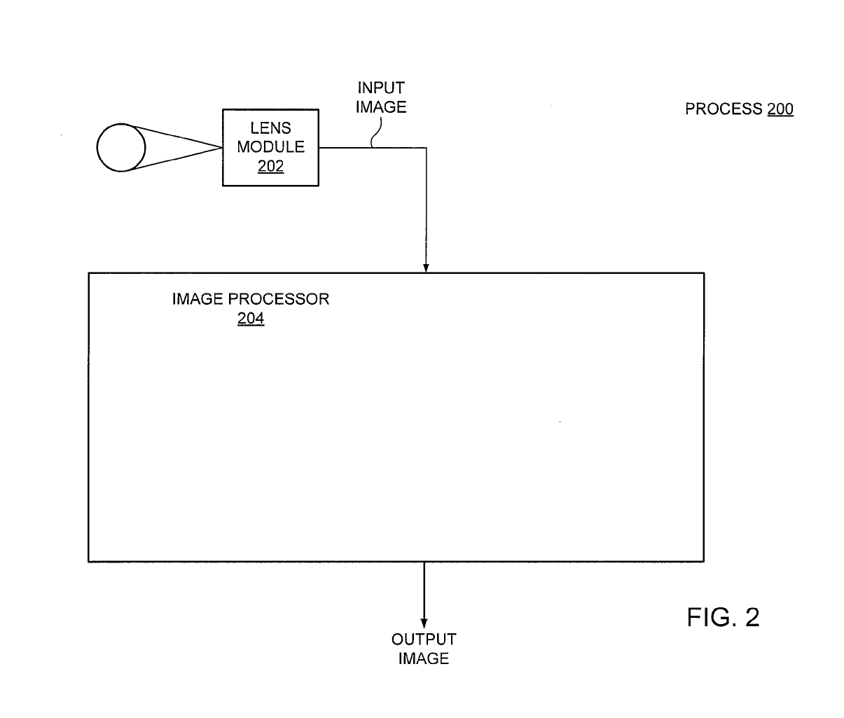

FIG. 2 is a functional block diagram that illustrates a camera 200 for capturing output images, according to one or more embodiments. The camera 200 utilizes a lens module 202 and an image processor 204 to produce an output image. The lens module 202 is operatively coupled with the image processor 204 and captures images or video frames. The lens module 202 captures an input and sends the input as a two-dimensional image to the image processor 204. In some embodiments, the lens module 202 captures a beam of light and produces the two-dimensional image, hereinafter referred to as the input image.

The Image processor 204 includes a circuit that receives the input image and eventually produces the output image by performing various operations, such as inpainting, texture quilting, texture stitching and/or the like. In some embodiments, the image processor 204 includes hardware components for executing image processing software (e.g., the image processing software 108 of FIG. 1). The output image may initially include some or all of known portions (i.e., source regions) of the input image. Alternatively, the input image may include none of the known portions. As explained in the description below, the image processor 204 determines intensity values for pixels within target regions, which may be unknown or missing pixels of the output image.

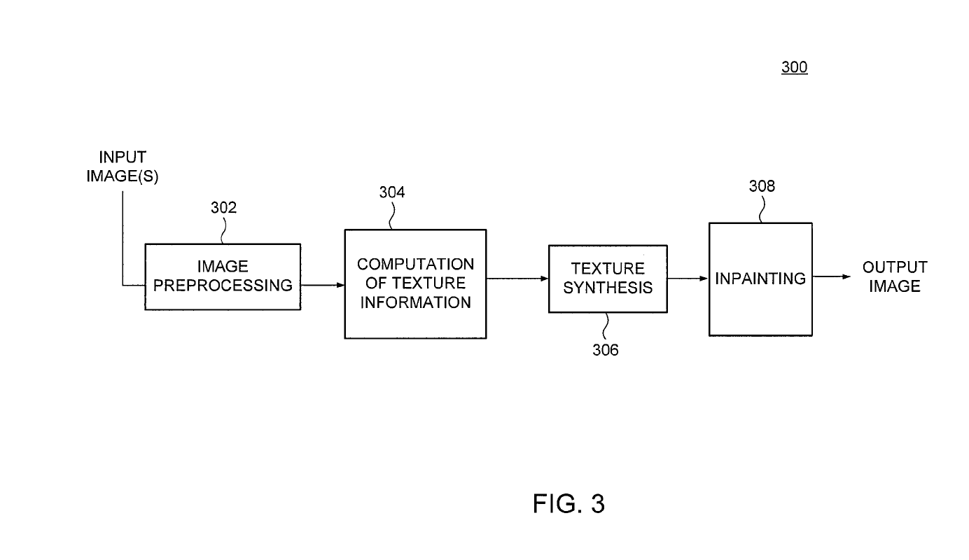

FIG. 3 is a functional block diagram illustrating a process 300 for reducing artifacts while converting an input image into an output image using an accurate target region in accordance with at least one embodiment. In some embodiments, an image processor (e.g., the image processing software 108 of FIG. 1) executes each and every module to perform the process 300.

Initially, an image preprocessing module 302 accesses and then, executes various functions (e.g., filtering) on the input image. In some embodiments, the preprocessed input image is transmitted to a texture computation module 304. Using the preprocessed input image, the texture computation module 304 determines texture values for pixel locations within the input image. After storing the texture values in texture information (e.g., the texture information 112 of FIG. 1), the image processor continues performing the various functions to produce the output image.

In some embodiments, the image processor proceeds to inpaint unknown or target regions (e.g., missing or occluded pixels) within the output image. For example, the image processor may remove a portion of the output image while executing various image processing techniques, such as object removal, object retargeting, occluded region inpainting and/or the like. The inpainting module 306 classifies each pixel in an image domain as known (a source region) or unknown (a target region).

In some embodiments, the unknown pixels may be further classified as occluded. The image processor may project pixel locations of the input image onto corresponding pixel locations of the output image for the purpose of producing a stereoscopically complimentary left eye and right eye image pair. Alternatively, the image processor may perform the projection in order to create another image that is directed in a different view. Using intensity values associated with integer pixel locations within the input image, the inpainting module 306 interpolates intensity values, respectively, for floating point pixel locations. The inpainting module 306 classifies any floating point pixel locations to which no intensity value can be interpolated as occluded pixels.

In some embodiments, the image processor uses the inpainting module 306 to perform an inpainting process for computing intensity values for the occluded pixels using source regions from the input image. The inpainting module 306 examines candidate patches (i.e., blocks) for a source region that is most similar to a block including a current target region to be inpainted. Pixels within such a source region closely match known pixels in the current target region. Similarity amongst blocks of pixels is computed according to various metrics as explained further below in the description.

According to other embodiments, the image processor reproduces a texture (mesh) from one or more input images (i.e., samples). In other words, the image processor starts with a blank image and creates the output image using various portions of one or more input images. In some embodiments, a texture synthesis module 308 computes an intensity value for a particular pixel by blending intensity values from known, input pixels that are similar in color and texture.

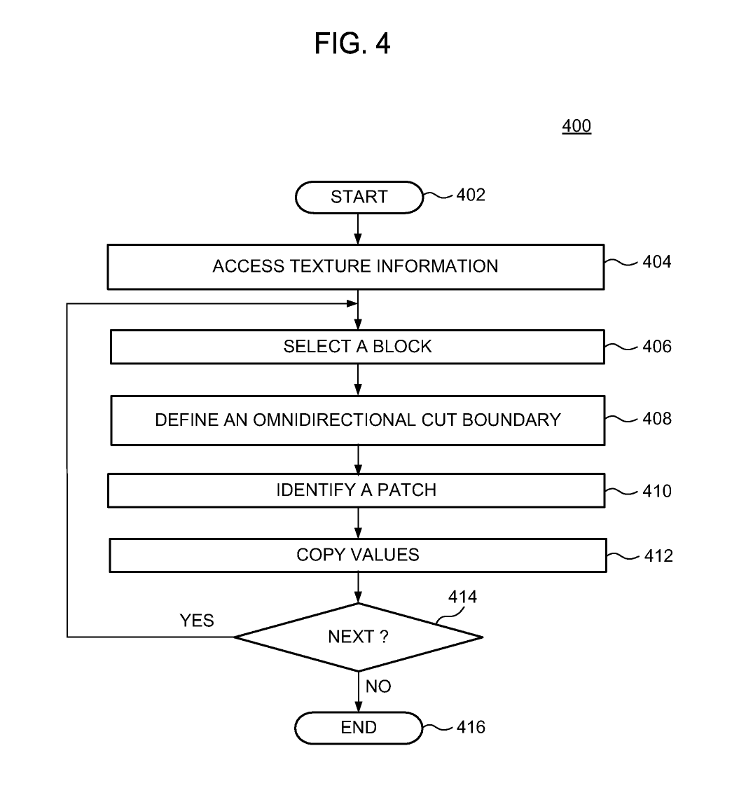

FIG. 4 is a flow diagram of a method 400 for reducing artifacts during image processing in accordance with at least one embodiment. In some embodiments, image processing software (e.g., the image processing software 108 of FIG. 1) performs each and every step of the method 400. In other embodiments, one or more steps are omitted. The method 400 starts at step 402 and proceeds to step 404.

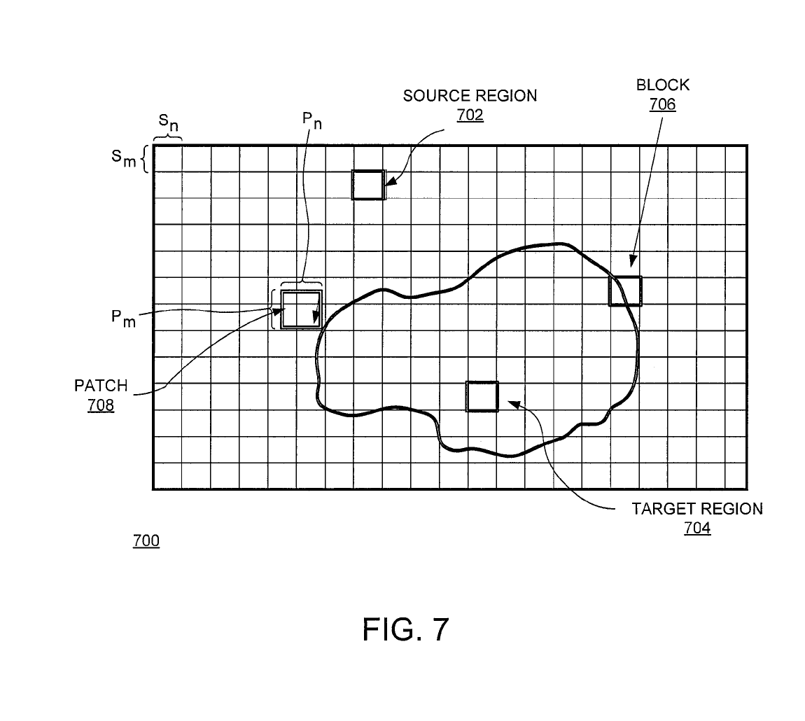

At step 404, the method 400 accesses texture information and examines texture values for each pixel within an input image. At step 406, the method 400 selects a block of an output image that includes a target region as well as one or more known pixels. At step 408, the method 400 defines an omnidirectional cut boundary for the target region. In some embodiments, the block of pixels is expanded to include surrounding pixels similar to the source region. At step 410, the method 400 examines the source regions to identify a patch to inpaint the selected block. In some embodiments, the identified patch is included within a group block of pixels that forms a shape that is similar to an expanded target region. The inpainting process is further explained in the description of FIG. 7.

At step 412, the method 400 copies intensity values from the block having the identified source region to corresponding pixel locations associated with the expanded target region within the block to be inpainted. At step 414, the method 400 determines whether there is a next block to be inpainted. If the method 400 determines that there are more blocks of pixels to be inpainted, the method 400 returns to step 406. If, on the other hand, the method 400 determines that each and every target region is inpainted, the method 400 proceeds to step 416. At step 416, the method 400 ends.

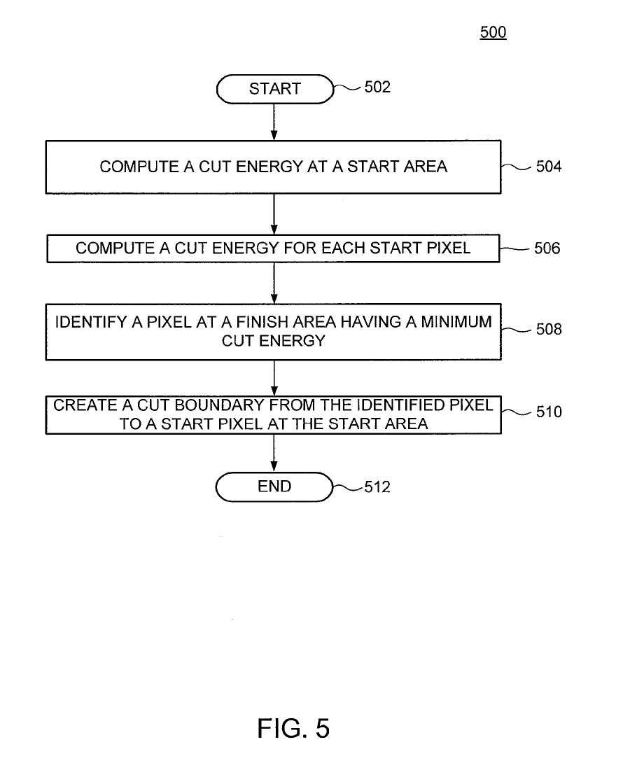

FIG. 5 is a flow diagram of a method 500 for defining an omnidirectional cut boundary for a target region within a block of pixels in accordance with at least one embodiment. In some embodiments, image processing software (e.g., the image processing software 108 of FIG. 1) performs each and every step of the method 500. In other embodiments, one or more steps are omitted. In some embodiments, the method 500 utilizes a dynamic programming technique to define the omnidirectional cut boundary. The method 500 starts at step 502 and proceeds to step 504.

At step 504, the method 500 computes a cut energy value for each pixel at a start area of the block. After comparing the block to candidate blocks, the method 500 identifies a candidate block having a source region that is most similar to the block to be inpainted. Accordingly, the cut energy quantifies the dissimilarity between color components of a pixel at the block (i.e., a boundary block) and color components of a corresponding pixel at the identified candidate block. Using the following equation, the method 500 initializes cut energies for each pixel location (i, j) at the start area by computing a means square error with a corresponding start pixel in the candidate block:

E_{i,j}=e(i,j)=(R₁−R₂)²+(G₁−G₂)²+(B₁−B₂)²

At step 506, the method 500 computes a cut energy value for each and every intermediate pixel. In some embodiments, the method 500 computes a cut energy for an intermediate pixel location (i,j) based on cut energies associated with one or more surrounding pixels. For example, the method 500 computes the cut energy for the intermediate pixel location (i,j) using the following equation:

$${E}_{i , j } = e ( i , j ) + {min}_{i , j} [ {E}_{i - 1 , j} , {E}_{i - 1 , j - 1} , {E}_{i , j - 1} , {E}_{i + 1 , j - 1} ]$$

At step 508, the method 500 identifies a pixel at a finish area having a minimum cut energy value. At step 510, the method 500 creates a cut boundary (i.e., a path) from the identified pixel to the start area. In some embodiments, the method 500 defines the cut boundary by tracing backwards from the identified pixel to a particular pixel at the start area. The method 500 selects one or more intermediate pixels that form the cut boundary and correspond with a minimum cut energy. Because the method 500 may select any intermediate pixel along any direction from the finish area, the cut boundary is omnidirectional. At step 512, the method 500 ends.

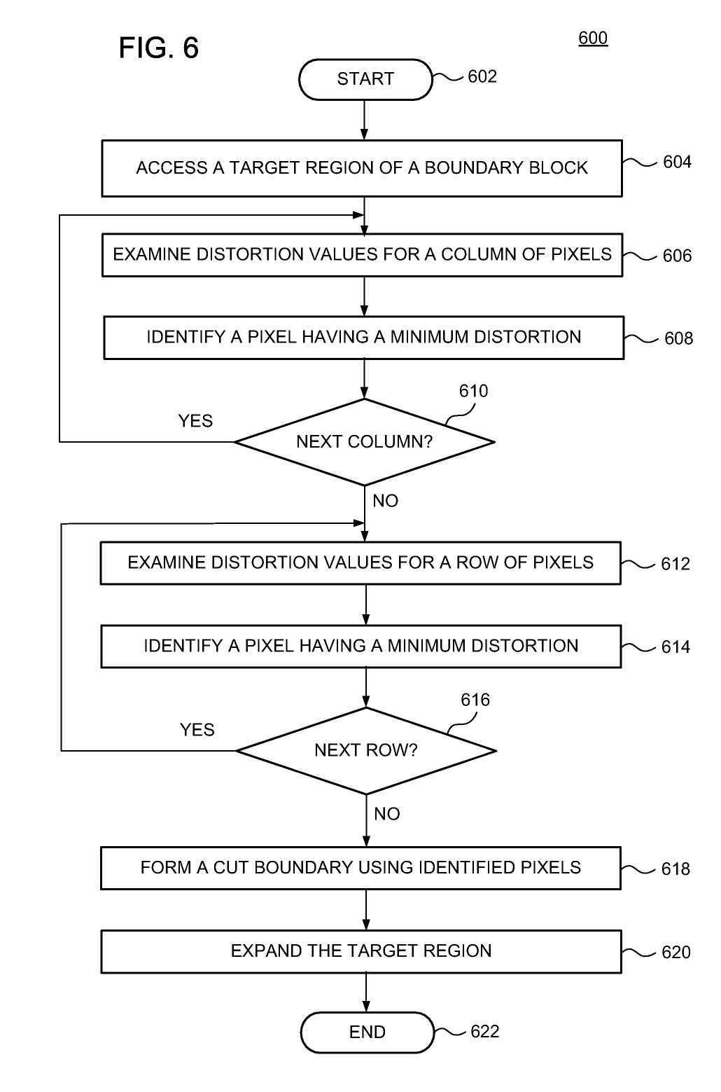

FIG. 6 is a flow diagram of a method 600 for determining an omnidirectional cut boundary that defines an accurate target region in accordance with at least one embodiment. In some embodiments, image processing software (e.g., the image processing software 108 of FIG. 1) performs each and every step of the method 600. In other embodiments, one or more steps are omitted. The method 600 starts at step 602 and proceeds to step 604.

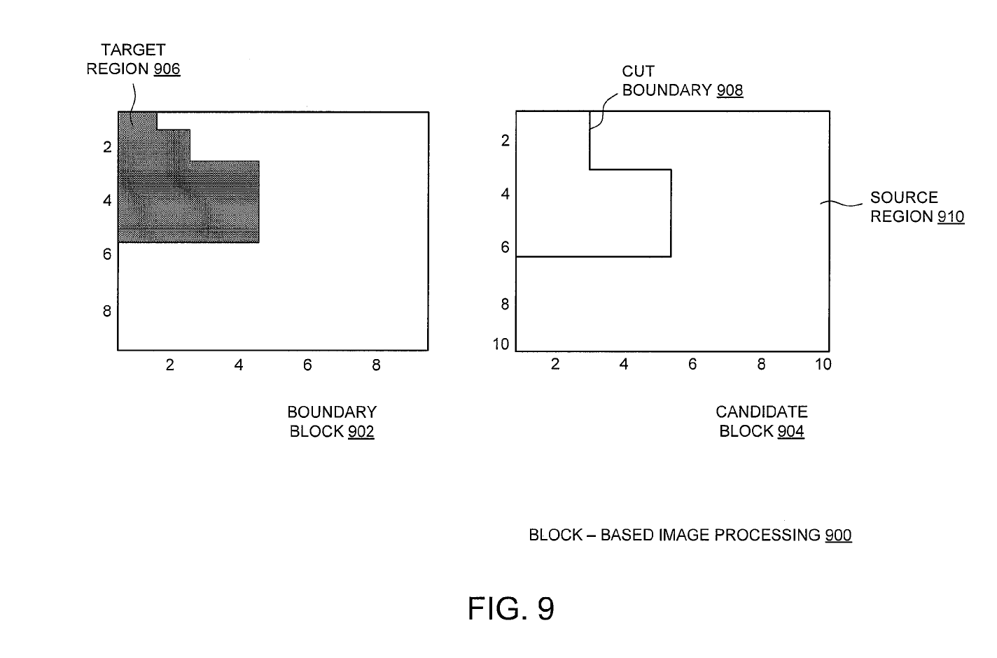

At step 604, the method 600 examines a target region of a block to be inpainted. In some embodiments, the examined block is located along a contour of all of the target regions. At step 606, the method 600 examines distortion values for each pixel in a column of the image. For example, these distortion values may be associated with an output image and indicate a similarity between the column of the output image and a corresponding column of the input image. The distortion values are stored in similarity data and represented as a matrix (i.e., an error matrix). Accordingly, each distortion value indicates a similarity between color components (i.e., Red (R), Green (G) and Blue (B)) of two pixels. Both pixels correspond to a same pixel location within a boundary block and a candidate patch (block), as explained in detail below for FIG. 9. In some embodiments, the distortion value for both of these pixels is calculated using the following equation:

Distortion (Error)=(R₁−R₂)²+(G₁−G₂)²+(B₁−B₂)²

At step 608, the method 600 identifies a pixel having a minimum distortion along the column. At step 610, the method 600 determines whether there is a next column to be inpainted. If the method 600 determines that there are more columns of pixels to be inpainted, the method 600 returns to step 606. If, on the other hand, the method 600 determines that there are no more columns, the method 600 proceeds to step 612. At step 612, the method 600 examines distortion values for each pixel in a row of the image. At step 614, the method 600 identifies a pixel having a minimum distortion.

At step 616, the method 600 determines whether there is a next row to be inpainted. If the method 600 determines that there are more rows of pixels to be inpainted, the method 600 returns to step 618. If, on the other hand, the method 600 determines that there are no more rows, the method 600 proceeds to step 618. At step 618, the method 600 forms an omnidirectional cut boundary using the identified pixels. The target region and each pixel between the target region and the cut boundary constitute an accurate target region. At step 620, the method 600 expands the target region to include the pixels within the cut boundary. At step 622, the method 600 ends.

FIG. 7 illustrates a schematic depicting an image 700 comprising a source region 702, a target region 704 and a block 706 according to one or more embodiments. The image 700 may be an output image (e.g., the output image 118 of FIG. 1) produced by a device used for image processing (e.g., the device 100 of FIG. 1). The source region 702 includes blocks of pixels that include pixel information. The target region 704 also includes blocks of pixels, but these blocks may include no and/or incorrect pixel information (i.e., the target region 704 is a portion of the image 700 to be in-painted using pixel information from the source region 702).

The block 706 may be located on a boundary between the target region 704 and the source region 702 (i.e., a boundary block). As such, the block 706 overlaps a portion of the source region 702 and a portion of the target region 704. The block 706 includes the intensity and texture values provided by the overlapping portions of the source region 702 according to one or more embodiments. The patch 708 may includes pixels from the source region 702 that is located to the right or the left of the block 706. Because the target region 704 within the block 706 is expanded, the patch 708 may form an irregularly shaped, closed polygon.

Intensity values associated with the blocks in the source region 702 of the patch 708 are used to determine optimal intensity values for pixels in the portion of the block 706 containing the target region 704. Intensity values of each patch are examined in order to identify a matching patch 708. In some embodiments, an image processor searches all of the patches are confined within a search area for a patch that matches known pixels within the block 706. Such a search area may be defined as a dynamic range of eleven pixels from a center pixel of the block 706 towards a right, a top or a bottom direction. The blocks within the search area are used as candidates for various operations, such as image inpainting or texture synthesis.

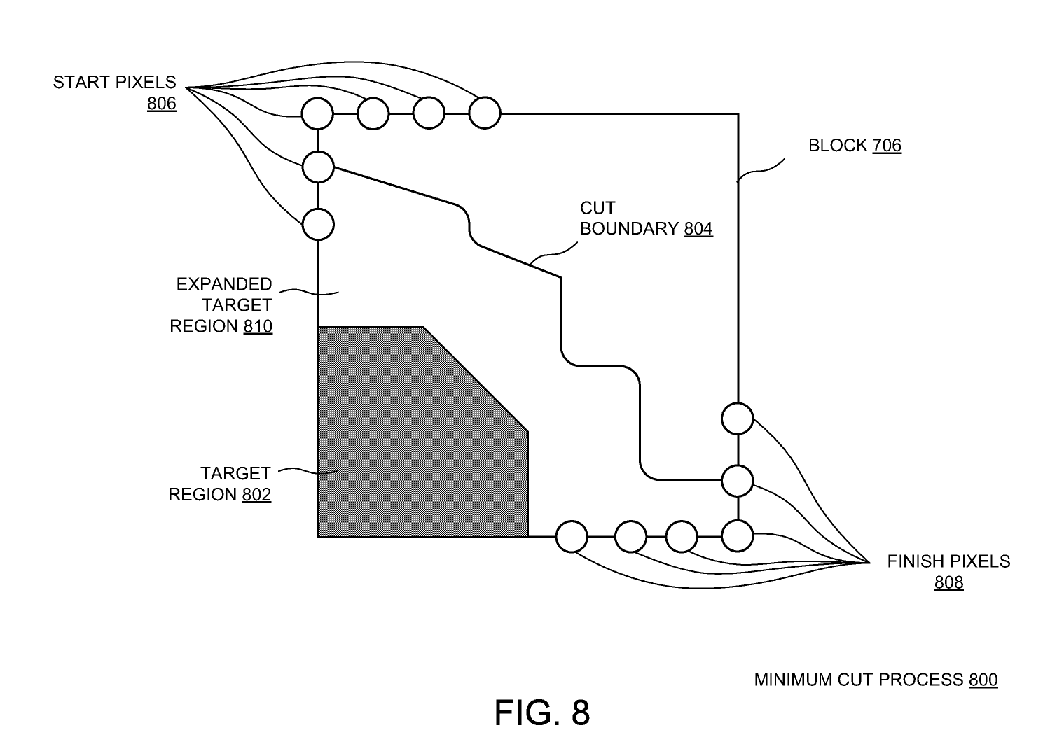

FIG. 8 illustrates a minimum cut process 800 that reduces artifacts when performed on a block of pixels in accordance with at least one embodiment. The block includes a target region 802 whose pixels are unknown. The minimum cut process 800 defines a cut boundary 704, which is later used to inpaint the target region 802 using pixel values from a source region at another block (i.e., a candidate block). The target region 802 is expanded to include each and every pixel up to and including the cut boundary 804. As such, the cut boundary constitutes an omnidirectional contour of an expanded target region 810. In some embodiments, intensity values are copied into the expanded target region 810 from corresponding pixel locations within the source region. These values overwrite any pre-existing values within the expanded target region 810.

FIG. 9 illustrates block-based image processing 900 that reduces artifacts using an accurate target region in accordance with at least one embodiment. After comparing a boundary block 902 to each and every block of known pixels (i.e., source regions), a candidate block 904 is selected to inpaint the target region 806. The target region 806 is expanded to include surrounding pixels. In some embodiments, the surrounding pixels between the target region 806 and a cut boundary 808 constitute a more accurate target region for image processing. The cut boundary 808 may be defined using methods (e.g., the method 500 of FIG. 5 and the method 600 of FIG. 6) in accordance with various embodiments.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated display device via inter-computer communication. Some or all of the device components or data structures may also be stored (e.g., as instructions or structured data) on a computer-accessible medium or a portable article to be read by an appropriate drive, various examples of which are described above. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While, the present invention is described in connection with the preferred embodiments of the various figures. It is to be understood that other similar embodiments may be used. Modifications/additions may be made to the described embodiments for performing the same function of the present invention without deviating therefore. Therefore, the present invention should not be limited to any single embodiment, but rather construed in breadth and scope in accordance with the recitation of the appended claims.

While the foregoing is directed to embodiments of the present invention, other and further embodiments of the invention may be devised without departing from the basic scope thereof, and the scope thereof is determined by the claims that follow.

1. A computer implemented method for reducing artifacts during image processing, comprising:
examining an input image comprising at least one source region;
for each target region in an output image:
identifying a portion of the at least one source region based on similarity data;
defining an omnidirectional cut boundary; and
determining intensity values for the each target region and at least one pixel between the each target region and the omnidirectional cut boundary.

2. The method of claim 1, wherein the omnidirectional cut boundary varies for the each target region.

3. The method of claim 1 further comprising expanding the each target region to comprise the cut boundary.

4. The method of claim 1, wherein defining the omnidirectional cut boundary further comprising:
computing a cut energy for each pixel of a first area;
identifying a pixel at a second area having a minimum cut energy; and
creating the omnidirectional cut boundary from the identified pixel to the first area.

5. The method of claim 4 further comprising computing a starting cut energy for the first area.

6. The method of claim 1, wherein defining the omnidirectional cut boundary further comprising:
identifying at least one pixel, wherein each pixel corresponds with a minimum distortion within a portion of the boundary block;
expanding the each target region to comprise the at least one pixel.

7. The method of claim 1 further comprising:
for each column of the boundary block,
identifying a first pixel within the at least one source region having a minimum distortion; and
for each row of the boundary block,
identifying a second pixel within the at least one source region having a minimum distortion.

8. The method of claim 7, wherein the each column and the each row of the boundary block comprises a portion of the each target region.

9. An apparatus for reducing artifacts during image processing, comprising:
a lens module for capturing an input image; and
an image processor for
examining an input image comprising at least one source region,
for each target region in an output image:
identifying a portion of the at least one source region based on similarity data,
defining an omnidirectional cut boundary, and
determining intensity values for the each target region and at least one pixel between the each target region and the omnidirectional cut boundary.

10. The apparatus of claim 9, wherein the image processor expands the each target region to comprise the omnidirectional cut boundary.

11. The apparatus of claim 9, wherein the image processor computes a cut energy for each pixel in a first area, identifies a pixel at a second area having a minimum cut energy and creates a path from the identified pixel to the first area, wherein the area comprises the omnidirectional cut boundary.

12. The apparatus of claim 11, wherein the image processor computes a starting cut energy for the first area.

13. The apparatus of claim 9, wherein the image processor identifies at least one pixel, wherein each pixel corresponds with a minimum distortion within a portion of the boundary block and expands the each target region to comprise the at least one pixel.

14. The apparatus of claim 9, wherein the image processor, for each column of the boundary block, identifies a first pixel within the at least one source region having a minimum distortion and, for each row of the boundary block, identifies a second pixel within the at least one source region having a minimum distortion.

15. The apparatus of claim 9, wherein the each column and the each row of the boundary block comprises a portion of the each target region.

16. The apparatus of claim 9, wherein the omnidirectional cut boundary varies for the each target region.

17. A computer readable storage medium comprising one or more processor executable instructions that, when executed by at least one processor, causes the at least one processor to perform a method comprising:
examining an input image comprising at least one source region;
for each target region in an output image:
identifying a portion of the at least one source region based on similarity data;
defining an omnidirectional cut boundary; and
determining intensity values for the each target region and at least one pixel between the each target region and the omnidirectional cut boundary.

18. The computer-readable-storage medium of claim 17, wherein the one or more processor executable instructions perform the method further comprising:
for each column of the boundary block,
identifying a first pixel within the at least one source region having a minimum distortion; and
for each row of the boundary block,
identifying a second pixel within the at least one source region having a minimum distortion.

19. The computer-readable-storage medium of claim 17, wherein the one or more processor executable instructions perform the method further comprising:
identifying at least one pixel, wherein each pixel corresponds with a minimum distortion within a portion of the boundary block; and
expanding the each target region to comprise the at least one pixel.

20. The computer-readable-storage medium of claim 17, wherein the one or more processor executable instructions perform the method further comprising:
computing a cut energy for each pixel in a first area;
identifying a pixel at a second area having a minimum cut energy; and
creating the omnidirectional cut boundary from the identified pixel to the first area.
